(19) United States
(12) Patent Application Publication
(10) Pub. No.: US 2003/0122368 A1
(43) Pub. Date: Jul. 3, 2003

(54) Advertising device and method

(76) Inventor: Hubert McCarthy, Calgary (CA)

Correspondence Address: COLLARD & ROE, P.C., 1077 Northern Boulevard, Roslyn, NY, 11576, US

(21) Appl. No.: 10/034,481

(22) Filed: Dec. 27, 2001

(51) Int. Cl. G09F 1/00

(52) U.S. Cl. 283/56

(57) ABSTRACT

The invention relates to a NEW ADVERTISING MEDIUM and method involving the printing of advertising material in the form of text and/or half-tone graphical images, on regular consumable print paper. A sheet of paper is provided having a front surface, and a reverse surface, the front surface being blank, and the reverse surface having the advertising material printed thereon. The ink used to print the advertising material is lightly colored or reduced in density, and the paper is of a grade sufficient to limit the visibility of the advertising material through the paper from the front surface thereof. The paper may also be of a distinctive non-white color or include a distinctively colored marking. The invention includes a new method of advertising in the form of printing advertising material on the consumable print paper of the invention. The invention further includes a method of generating revenue through the sale of advertising space on the consumable print paper of the invention, wherein the consumable paper may be sold at a price lower than comparable paper not bearing advertisements.

### FIELD OF THE INVENTION

The present invention relates generally to the field of advertising devices and paper products, and in particular to a NEW ADVERTISING MEDIUM and method involving the printing of unobtrusive advertising on regular consumable paper stock intended for informal uses by the home computer user or for intra-office communication.

### BACKGROUND OF THE INVENTION

Many merchandisers are spending vast sums of money on advertising through radio and on television. Advertising leaflets and flyers, and print ads in various media, such as newspapers, are also common. Since these advertising products are most often viewed, heard or read and then immediately discarded, merchandisers must rely on the consumer to retain the advertising messages in memory against the day when the consumer has need to contact the merchandiser to purchase their products or services. In the alternative, the merchandiser must rerun the advertisements by purchasing additional radio or television time, by printing and distributing more leaflets and flyers, or by purchasing additional advertising space in newspapers and magazines.

One solution to this problem is to place advertisements for one product on packages for an unrelated consumer product. While this does provide some advertising exposure, and retention, packaging is usually discarded soon after a product is acquired, and before it is used.

Another solution would be to place advertisements for an unrelated product directly on a target product to be purchased and retained by a consumer, rather than on the packaging for same. This is not normally considered an option, because it would tend to detract from the appearance or functionality of the target consumer product.

U.S. Pat. No. 6,254,960, issued to Liang-Ji Chen on Jul. 3, 2001, describes a memo block in which designs or advertisements are printed on the fore section of the top surface of each sheet of note paper in the block. However, these designs or advertisements are obtrusive to the user as they appear on the same surface intended to be used for writing.

Accordingly, there is a need for a target consumer product that has advertising printed directly on the product in an unobtrusive manner that does not detract from the appearance or functionality of the target product.

### SUMMARY OF THE INVENTION

The applicant has recognized that the average home consumer of printable paper products uses the paper for routine printing of e-mails, Internet articles, jokes, personal financial details, draft letters, data backup, handwritten notes, etc., rather than for formal communications or presentations. Moreover, the paper is used for printing or writing on one side only. The same is true in the office environment where much of the consumable print paper is used for informal purposes, such as for draft and file copies and for intra-office communication.

Accordingly, the applicant has devised a means for placing advertisements directly on printable paper products, without detracting from the appearance or functionality of the products.

In particular, the paper products that are most suitable are consumable print paper intended for home use in computer printers, photocopiers, typewriters, facsimile machines, and for handwriting, but may also include print paper intended for informal intra-office communication and for use in large printers. Currently, very large volumes of such paper, which is usually inexpensive and only medium grade, are produced and used in a variety of home situations and in offices. Almost universally, though, it is used for printing on one side only. The reverse side is left blank, and not printed on at all. According to the present invention advertisements are printed on the reverse side of such paper of a grade suitable for use in computer printers, photocopiers, facsimile machines, typewriters, large printers, or for handwriting.

An object of one aspect of the present invention, then, is to provide a consumable product, intended for the home or intra-office use, having advertising printed directly thereon, without detracting from the appearance or functionality of the product.

An object of another aspect of the present invention, is to provide a method of advertising that includes printing advertisements directly on a consumable product intended for the home or intra-office use, without detracting from the appearance or functionality of the product.

An object of yet another aspect of the present invention, is to provide a method of generating revenue by selling advertising space on a consumable product intended for the home or intra-office use, wherein the advertising is printed directly on the consumable product without detracting from the appearance or functionality of the product.

An object of a preferred embodiment of the invention is to provide a method of generating revenue by selling advertising space on a consumable product intended for the home or intra-office use, wherein the advertising is printed directly on the consumable product without detracting from the appearance or functionality of the product, and the consumable product is sold at a price lower than a comparable product not bearing advertisements.

In a broad aspect, then, the present invention relates to a business form, intended for home or intra-office use, comprising a sheet of paper with a front surface, and a reverse surface, the front surface being blank, and the reverse surface having advertising material printed thereon.

In another broad aspect, the present invention relates to a method of advertising comprising printing advertising material on a reverse surface of a business form intended for home or intra-office use, the form comprising a sheet of paper with a front surface and the said reverse surface, the front surface being blank, and the reverse surface having space for printing advertising material thereon.

In a further broad aspect, the present invention relates to a method of generating revenue through the sale of advertising space, comprising allocating space for advertisers on a reverse surface of a business form intended for home or intra-office use, the form comprising a sheet of paper with a front surface and the said reverse surface, the front surface being blank, and the reverse surface having space for printing advertising material thereon; setting a rate for the placement of an advertisement in the space; printing at least one advertisement from at least one advertiser in the space, for consideration; and distributing the form.

In yet another broad aspect, a preferred embodiment of the present invention relates to a method of generating revenue through the sale of advertising space, comprising: allocating space for advertisers on a reverse surface of a business form intended for home or intra-office use, the form comprising a sheet of paper with a front surface and the said reverse surface, the front surface being blank, and the reverse surface having space for printing advertising material thereon; setting a rate for the placement of an advertisement in the space; printing at least one advertisement from at least one advertiser in the space, for consideration; and distributing the form at a price lower than comparable forms not bearing advertisements

The present invention is a NEW ADVERTISING MEDIUM that advantageously permits one or more merchandisers to place advertising material on a consumer product intended for the home or intra-office use, without detracting from the appearance or functionality of the product. A further advantage of the invention is that the advertising remains on the product while the product is used by the consumer, in such a manner that the advertising material is continuously available to the consumer while the product is in use. Another advantage of the invention is that it also provides a method of generating revenue by selling advertising space on the target consumer product. Moreover, the price of the target consumer product can be advantageously reduced compared to similar products without advertising. This gives retailers the ability to generate sales of the target consumer product during slack periods. A further advantage of the invention is that the consumer product can be made a distinctive color or include a distinctive colored marking to distinguish it from other consumer products that do not contain the advertising material.

Further objects and advantages of the present invention will be apparent from the following description, wherein preferred embodiments of the invention are clearly shown.

### BRIEF DESCRIPTION OF THE DRAWINGS

In drawings that illustrate the present invention by way of example:

FIG. 1 is a front view of a piece of paper of a size and grade suitable for a photocopier or large printer; and

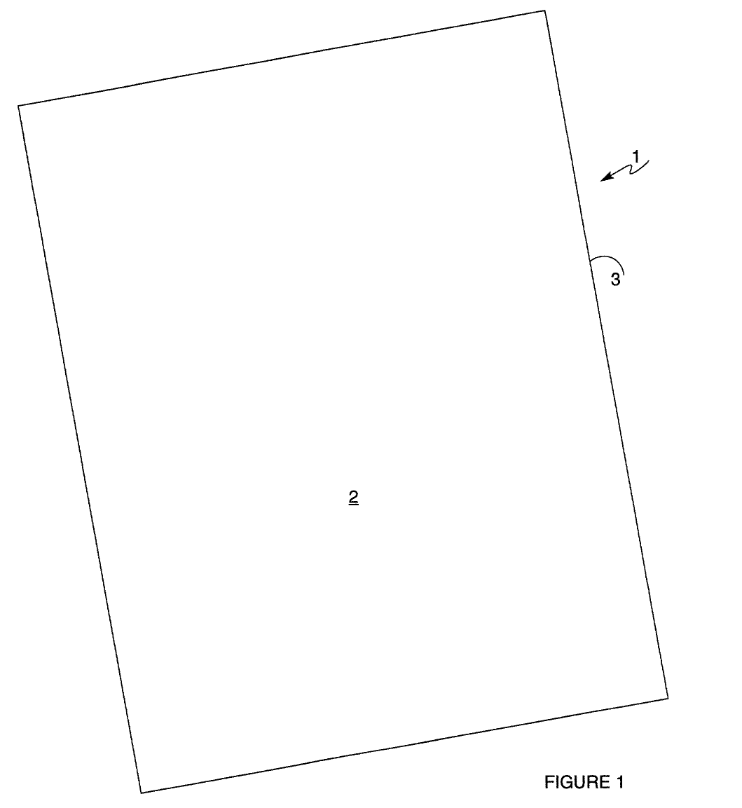

FIG. 2 is a view of the reverse side of the piece of paper of FIG. 1, showing advertisements printed on same.

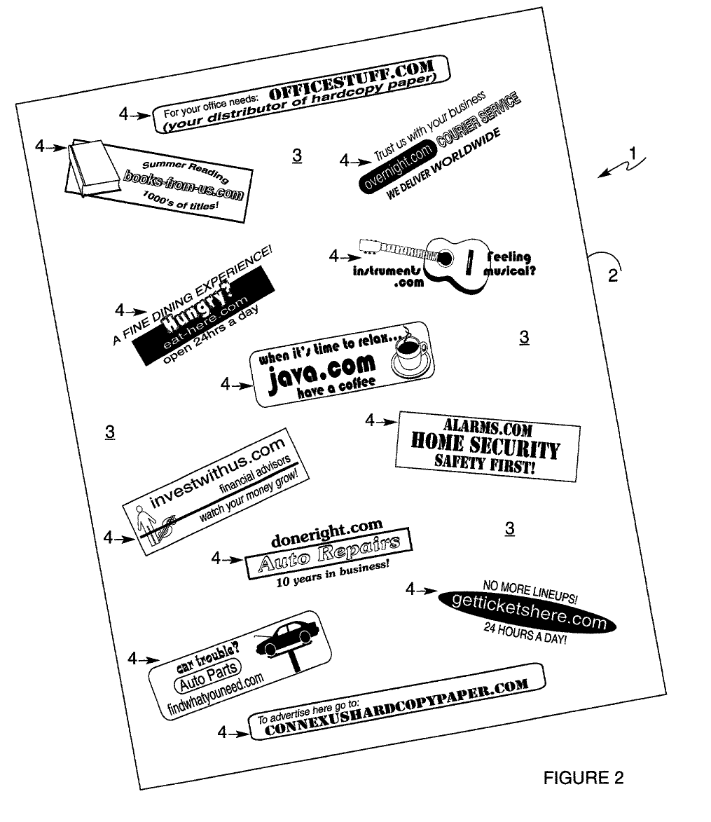

### DETAILED DESCRIPTION

The present invention is shown in the drawings. A NEW ADVERTISING MEDIUM, comprises a business form intended for home or intra-office use, comprising a piece of paper 1 having a front surface 2 that is left blank and is suitable for accepting printing with a computer printer, a photocopier, a typewriter, a facsimile machine, a large printer, or the like, or handwriting, and a reverse surface 3 that is normally left blank. According to the present invention, the reverse surface 3 has advertisements 4 printed thereon. Advertising material 4 may be any desired text or graphic design or a combination of text and a design.

In order to ensure that advertisements 4 are not easily visible or distracting through the paper 1, it is helpful to print them in lightly tinted ink selected to be unobtrusive in appearance. It is also preferable to print advertisements 4 in text only, or in half tone images, and to use a combination of one to seven colors of ink. Of course, any combination of text and half tone imaging is possible. To further ensure that advertisements 4 on reverse surface 3 are as unobtrusive as possible, a process called screening is used to reduce the density of certain colors of ink deposited on the paper. Screening values can range from 0% to 100%, with larger screening values corresponding to lower densities of ink being deposited on the paper. The amount of screening used depends on the color of ink to be printed, the density of the image, and the paper color selected. It will be appreciated that darker colors of ink, more dense images, and lighter colors of paper will require higher screening values. Preferably, advertisements 4 of the present invention are printed using ink screening values in the range of 5% to 95%

To further ensure that advertisements 4 are not easily visible or distracting through paper 1, it is helpful if the grade of paper 1 is sufficient to obscure advertisements 4 from being visible through paper 1 from the front surface 2 thereof. At the same time, however, the grade of paper used must be capable of functioning in typical home and office printing equipment such as computer printers, photocopiers, facsimile machines, and typewriters, and must be sufficiently inexpensive to appeal to such informal users. Preferably, paper having grades in the range of 20 pound to 24 pound is used for the present invention, however, the use of better grades of paper would also be suitable.

In addition, paper 1 can be made a distinctive non-white color, so as to assist in distinguishing it from other paper that is normally white and does not contain advertisements 4. This can be helpful in office or home situations where it is necessary to readily distinguish the present invention, which is intended for informal uses and draft copies, from print paper which is intended for use in preparing formal correspondence and presentations. In the alternative, paper 1 can include a distinctively colored flash, stripe or other marking for the purposes of distinguishing.

As noted above, the present invention comprises a NEW ADVERTISING MEDIUM and also includes a novel method of advertising, which comprises printing advertisements 4 on reverse surface 3 of paper 1, in the manner described herein. It is preferable that advertisements 4 printed on reverse surface 3 are directed to the home computer user and include advertisements from individuals or companies whose businesses are dependent on a global computer network, such as the Internet, and that wish to target the home computer user, or advertisers having a presence on a global computer network, and wishing to gain exposure to the home computer user. The advertisements will preferably include only a small website logo and a text message giving the advertiser's website address, but could contain other messages or graphic images if desired. Preferably, a set of advertisements, comprising a maximum of ten (10) separate advertisements, is printed on reverse surface 3 of each paper 1. Typically, paper 1 is sold in bundles of from 100 to 500 sheets. In these situations, the set of advertisements on each sheet of paper 1 in the bundle can be the same, or preferably, there are several different sets of advertisements that repeat periodically throughout the bundle. For example, in a preferred embodiment, there are four sets of ten advertisements that repeat throughout the bundle. It will be appreciated that each set may comprise more or less than ten separate advertisements and there can be more or less than four repeating sets in each bundle of paper.

The present invention further comprises a novel method of generating revenue by selling advertising space on the reverse surface 3 of consumer print paper 1 being sold or otherwise distributed and intended for home or intra-office use in computer printers, photocopiers, typewriters, facsimile machines, or the like, or for handwriting, or for use in large printers. The paper may be distributed and sold normally, or the advertising revenue generated by the sale of advertising space may be used to defray a portion of the cost of the paper, permitting it to be sold at a lower cost, thereby increasing the likelihood of additional sales, and providing more exposure for the advertiser. At an extreme, the paper may be given away, with all revenue being generated through advertisements, although this is not usually considered necessary, as the advertisements are preferably aesthetically pleasing, and unobtrusive.

It is preferable that the advertising space on the reverse surface 3 of paper 1 be sold to individuals or companies whose businesses are dependent on a global computer network, such as the Internet, and wish to target the home computer user. However, other individuals or businesses having a presence on a global computer network, such as the Internet, and wishing to gain exposure to the home computer user will also benefit from the purchasing of such advertising space. The advertisements will preferably include only a small website logo and a text message giving the advertiser's website address, but could contain other messages or designs if desired. Preferably, space to accommodate a set of advertisements comprising a maximum of ten (10) separate advertisements is sold on the reverse surface 3 of each sheet of paper 1. Typically, paper is sold in bundles of from 100 to 500 sheets. In these situations, the set of advertisements sold on each sheet of paper 1 in the bundle can be the same, or preferably, there are several different sets of advertisements that repeat periodically throughout the bundle. For example, in a preferred embodiment, there are four sets of ten advertisements that repeat throughout the bundle. It will be appreciated that each set may comprise more or less than ten separate advertisements and there can be more or less than four repeating sets in each bundle of paper

It is noted that the present invention has been described with particular reference to the home computer user and/or in respect of informal intra-office communications. However, the reader will readily appreciate that the invention may also have application in any situation where informal printed communications are generated and the user is not concerned with the presence of unobtrusive printed advertisements on the reverse surface of consumable print paper. Moreover, the methods of the invention have been described with particular reference to advertisers whose businesses are dependent on a global computer network, such as the Internet, or that have a presence on a global computer network, since it is believed that these are the advertisers that will wish to target the home computer user or the informal office environment. However, the reader will also readily appreciate that the methods of the invention also have application to traditional advertisers wishing to target the home computer user or informal office environment or any user of consumable print paper where the presence of unobtrusive printed advertisements on the reverse surface thereof is not a concern.

The invention may be embodied in other specific forms without departing from the spirit or essential characteristics thereof. The present embodiments are therefore to be considered as illustrative and not restrictive, the scope of the invention being indicated by the appended claims rather than by the foregoing description, and all changes that come within the meaning and range of equivalency of the claims are therefore intended to be embraced therein.

The embodiments of the invention in which an exclusive property or privilege is claimed are defined as follows:

1. A business form, intended for home or intra-office use, comprising a sheet of paper with a front surface, and a reverse surface, said front surface being blank, and said reverse surface having advertising material printed thereon.

2. A form as claimed in claim 1, wherein said advertising material is printed in ink selected to be unobtrusive in appearance.

3. A form as claimed in claim 1, wherein said advertising material is printed in ink using a screening value of from 5% to 95%.

4. A form as claimed in claim 1, wherein said paper is of a grade sufficient to obscure said advertising material from being visible through said paper, from the front surface thereof.

5. A form as claimed in claim 1, wherein said advertising material comprises text or graphical images, or a combination of text and graphical images.

6. A form as claimed in claim 1, wherein said advertising material includes images printed in half-tone.

7. A form as claimed in claim 6, wherein said half-tone printing is printed with 1, 2, 3, 4, 5, 6 or 7 colors.

8. A form as claimed in claim 1, wherein said paper is of a distinctive, non-white color.

9. A form as claimed in claim 1, wherein said paper includes a distinctively colored marking for the purposes of readily distinguishing said paper.

10. A method of advertising comprising printing advertising material on a reverse surface of a business form intended for home or intra-office use, said form comprising a sheet of paper with a front surface and said reverse surface, said front surface being blank, and said reverse surface having space for printing advertising material thereon.

11. The method claim 10, wherein said advertising material is printed in ink selected to be unobtrusive in appearance

12. The method of claim 10, wherein said advertising material is printed in ink using a screening value of from 0% to 60%

13. The method of claim 10, wherein said paper is of a grade sufficient to obscure said advertising material from being visible through said paper, from the front surface thereof.

14. The method of claim 10, wherein said advertising material comprises text or graphical images, or a combination of text and graphical images.

15. The method of claim 10, wherein said advertising material includes images printed in half-tone.

16. The method of claim 15, wherein said half-tone printing is printed with 1, 2, 3, 4, 5, 6 or 7 colors.

17. The method of claim 10, wherein said paper is of a distinctive, non-white color.

18. The method of claim 10, wherein said paper includes a distinctively colored marking for the purposes of readily distinguishing said paper.

19. A method of generating revenue through the sale of advertising space, comprising:
allocating space for advertisers on a reverse surface of a business form intended for home or intra-office use, said form comprising a sheet of paper with a front surface and said reverse surface, said front surface being blank, and said reverse surface having said space for printing advertising material thereon;
setting a rate for the placement of an advertisement in said space;
printing at least one advertisement from at least one advertiser in said space, for consideration; and
distributing said form.

20. The method of claim 19, wherein said form is distributed at a price lower than comparable forms not bearing advertisements.

21. The method of claim 19, wherein said advertisers are individuals or companies whose businesses are dependent on a global computer network, or that have a presence on said global computer network.

22. The method of claim 19, wherein said at least one advertisement is printed in ink selected to be unobtrusive in appearance.

23. The method of claim 19, wherein said at least one advertisement is printed in ink using a screening value of from 0% to 60%.

24. The method of claim 19, wherein said paper is of a grade sufficient to obscure said at least one advertisement from being visible through said paper, from the front surface thereof.

25. The method of claim 19, wherein said at least one advertisement comprises text or graphical images, or a combination of text and graphical images.

26. The method of claim 19, wherein said at least one advertisement includes images printed in half-tone.

27. The method of claim 26, wherein said half-tone printing is printed with 1, 2, 3, 4, 5, 6 or 7 colors.

28. The method of claim 19, wherein said paper is of a distinctive, non-white color.

29. The method of claim 19, wherein said paper includes a distinctively colored marking for the purposes of readily distinguishing said paper.
